(19) United States
(12) Patent Application Publication
(10) Pub. No.: US 2020/0193468 A1
(43) Pub. Date: Jun. 18, 2020

(54) BLOCKCHAIN FOR ADS AND COUPONS

(71) Applicant: James P. Rice, Akron, OH (US)

(72) Inventor: James P. Rice, Akron, OH (US)

(21) Appl. No.: 16/222,688

(22) Filed: Dec. 17, 2018

(51) Int. Cl. G06Q 30/02; G06K 7/14

(52) U.S. Cl. CPC G06Q 30/0225; G06K 7/1417

(57) ABSTRACT

The present application relates generally to blockchain technology, and more specifically to applications of blockchain technology for coupons and ads. In one aspect, a retailer and manufacturer enter into agreements with each other where the manufacturer agrees to reimburse the retailer for coupons that customers use to purchase a particular item using coupons. The retailer may distribute the coupons using a blockchain. Then, when customers use the blockchain coupons to purchase products, the retailer may be reimbursed at the point of sale by the manufacturer.

### BACKGROUND

The present application relates generally to blockchain technology, and more specifically to applications of blockchain technology for coupons and ads.

### BRIEF DESCRIPTION

In accordance with one aspect of the present application, a system includes: at least one processor; and at least one memory including computer program code. The at least one memory and the computer program may be code configured to, with the at least one processor, cause the system to: using a coupon on a blockchain, complete a transaction between a retailer and a customer.

In the system as described in the preceding paragraph, the at least one processor may be configured to execute the computer-readable instructions to cause the system to: using the coupon on the blockchain, dispense reimbursement to the retailer from a manufacturer. The at least one processor may be configured to execute the computer-readable instructions to cause the system to: using the coupon on the blockchain, simultaneously complete the transaction and dispense reimbursement to the retailer from a manufacturer.

In the system as described in any of the proceeding paragraphs, in some embodiments, a smart contract on the blockchain indicates an amount that the retailer will be reimbursed per purchase by a manufacturer; and the at least one processor is configured to execute the computer-readable instructions to cause the system to: using the coupon on the blockchain and the smart contract on the blockchain, dispense reimbursement of the amount to the retailer from the manufacturer. In some embodiments, a smart contract on the blockchain indicates a number of transactions that the coupon is valid for. In some embodiments, a smart contract on the blockchain indicates a time period that the coupon is valid for. In some embodiments, a smart contract on the blockchain indicates a geographic area that the coupon is valid for. In some embodiments, a smart contract on the blockchain indicates a particular retailer that the coupon is valid for.

In the system as described in any of the proceeding paragraphs, in some embodiments, the at least one processor is configured to execute the computer-readable instructions to cause the system to: place the coupon on the blockchain. In some embodiments, the at least one processor is configured to execute the computer-readable instructions to cause the system to: place a book of coupons on the blockchain, wherein the book of coupons on the blockchain includes the coupon. In the system as described in any of the proceeding paragraphs, in some embodiments, the at least one processor is configured to execute the computer-readable instructions to cause the system to: place a book of coupons on the blockchain, wherein the book of coupons on the blockchain includes: the coupon; and an advertisement for a new store opening. The at least one processor may be configured to execute the computer-readable instructions to cause the system to execute a smart contract that limits the coupon to the new store opening.

In the system as described in any of the proceeding paragraphs, in some embodiments, the at least one processor is configured to execute the computer-readable instructions to cause the system to: complete the transaction by receiving a quick response (QR) code from the customer. In some embodiments, the at least one processor is configured to execute the computer-readable instructions to cause the system to: display, to the customer, all coupons on the blockchain corresponding to a particular store of a particular retailer. In some embodiments, the at least one processor is configured to execute the computer-readable instructions to cause the system to: place a transaction identification number and timestamp corresponding to the transaction on the blockchain. In some embodiments, the blockchain is a private blockchain of the retailer or a manufacturer. In some embodiments, the at least one processor is configured to execute the computer-readable instructions to cause the system to: complete the transaction using a cryptocurrency. In some embodiments, the coupon is part of a plurality of coupons pre-funded by a manufacturer.

In the system as described in any of the proceeding paragraphs, in some embodiments, a first smart contract on the blockchain indicates an amount that the retailer will be reimbursed per purchase by a manufacturer; a second smart contract on the blockchain indicates a number of transactions that the coupon is valid for; a third smart contract on the blockchain indicates a time period that the coupon is valid for; a fourth smart contract on the blockchain indicates a geographic area that the coupon is valid for; a fifth smart contract on the blockchain indicates a particular retailer that the coupon is valid for; the blockchain is a private blockchain of the manufacturer; the coupon is part of a plurality of coupons pre-funded by a manufacturer; and the at least one processor is configured to execute the computer-readable instructions to cause the system to: place a book of coupons on the blockchain, wherein the book of coupons on the blockchain includes the coupon, and an advertisement for a new store opening; and display, to the customer, all coupons on the blockchain corresponding to the new store opening; using the coupon on the blockchain and the first smart contract on the blockchain, simultaneously complete the transaction and dispense reimbursement of the amount to the retailer from the manufacturer, wherein the transaction includes receiving a quick response (QR) code from the customer; place a transaction identification number and timestamp corresponding to the transaction on the blockchain.

In another aspect, there is a method, performed by one or more processors, comprising: using a coupon on a blockchain to complete a transaction between a retailer and a customer.

In another aspect, there is a system comprising one or more processors configured to: use a coupon on a blockchain to complete a transaction between a retailer and a customer.

### BRIEF DESCRIPTION OF THE DRAWINGS

FIG. 1 illustrates a previously known process where a manufacturer reimburses a retailer for items purchased with coupons.

FIG. 2 illustrates an embodiment of a blockchain system.

FIG. 3 illustrates an embodiment of a method described herein.

Advantageously, some embodiments prevent or reduce fraud.

Advantageously, some embodiments allow for faster reimbursement from the manufacturer to the retailer.

Advantageously, some embodiments identify individual transactions; whereas prior systems could count a total number of transactions, but not identify individual transactions.

### DETAILED DESCRIPTION

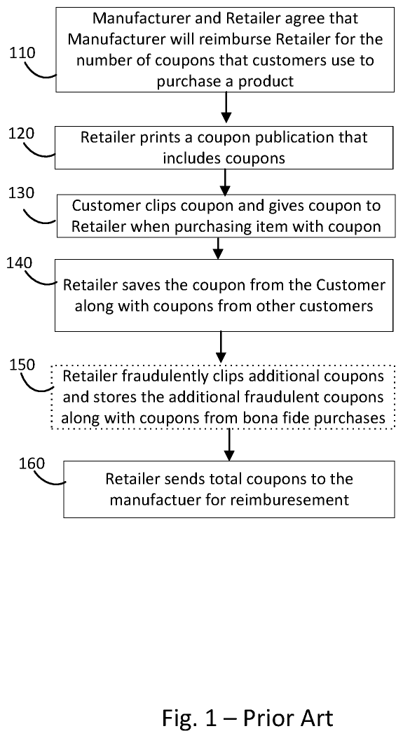

As illustrated by FIG. 1, currently, retailers and manufactures enter into agreements with each other where the manufacturer agrees to reimburse the retailer for a number of coupons that customers use to purchase a particular item using coupons (see, e.g., step 110). In this regard, a retailer may print a publication (e.g. in form of a free standing insert (FSI)) that includes coupons (see, e.g., step 120). A customer will give a coupon from the publication to the retailer when purchasing an item with the coupon (see, e.g., step 130). The retailer will then collect the coupons from customers (see, e.g., step 140). The retailer will then collect reimbursement from the manufacturer by providing the collected coupons to the manufacturer (see, e.g., step 160). However, unfortunately, sometimes retailers may cheat by fraudulently clipping additional coupons and adding them to the coupons collected from bona fide purchases (see, e.g., step 150).

It should be apparent that the terms “reimburse” and “reimbursement,” as used herein, mean (in addition to/in accordance with the plain and ordinary meaning of these words) currency of an amount specified by the agreement between the retailer and manufacturer and/or specified on the coupon itself.

In addition to the problem of fraud illustrated by step 150 of FIG. 1, another problem with current systems is that the retailer may have to wait for an extended period of time before collecting the reimbursement (e.g., the retailer might not send in coupons as they are collected; rather, the retailer sends the coupons in batches). As will be described below, the systems and methods described herein solve these problems and others.

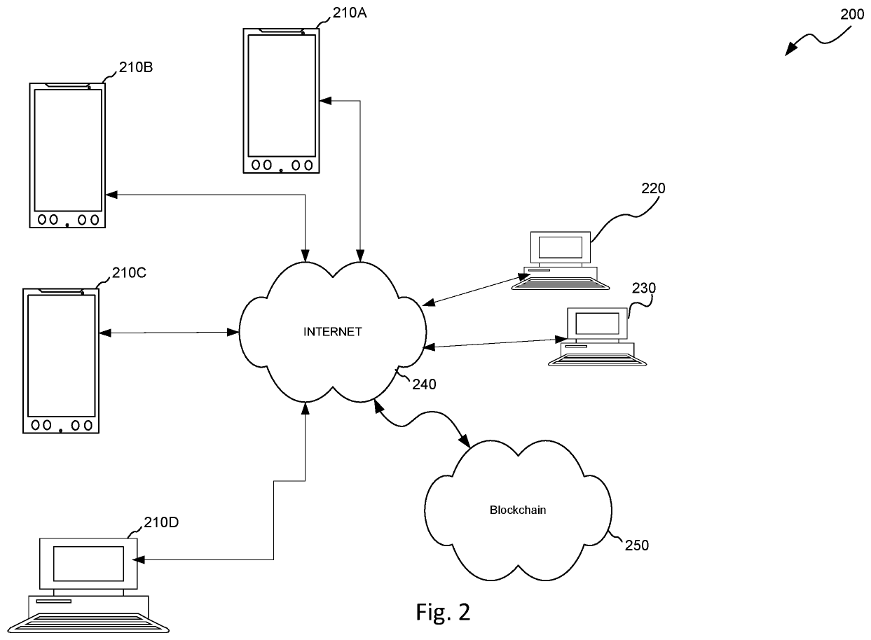

FIG. 2 illustrates an embodiment of a blockchain system. With reference thereto, blockchain system 200 includes customer devices 210A, 210B, 210C, 210D, manufacturer device 220, retailer device 230, internet 240 and blockchain 250. It will be appreciated that the various components depicted in FIG. 2 are for purposes of illustrating aspects of an embodiment, and that other similar components, implemented via hardware, software, or a combination thereof, are capable of being substituted therein. It will be further appreciated that internet 240 may be replaced with, for example and without limitation, a virtual local area network, a wide area network, a personal area network, a local area network, an intranet, or the any suitable combination thereof. It will be still further appreciated that the customer devices 210A, 210B, 210C, 210D, may be smartphones, tablets, personal computers, servers, any other devices, or any combination thereof. It will be still further appreciated that the manufacturer system 220 and retailer system 230 comprise server(s), smartphones, tablets, personal computers, any other devices, or any combination thereof.

Regarding blockchain 250, it should be noted that, generally, a blockchain, is a growing list of records (“blocks”), linked using cryptography. In each block, there is: a cryptographic hash of the previous block, a timestamp, and transaction data. Blockchains are designed to be secure (e.g. resilient to modification of information). In one aspect, a blockchain is an open ledger used to record transactions. Typically, a blockchain is managed by a peer-to-peer network following a protocol for inter-node communication and validating new blocks. After it is recorded, the data in any given block cannot be altered retroactively without alteration of all subsequent blocks, which requires consensus of a majority of the network. Although blockchain records are not unalterable, blockchains are generally considered secure by design.

It should further be noted that blockchain 250 may be used as or in connection with a blockchain such as Bitcoin, Ethereum® or so forth. It should still further be noted that blockchain 250 may be used as or in connection with any other blockchain.

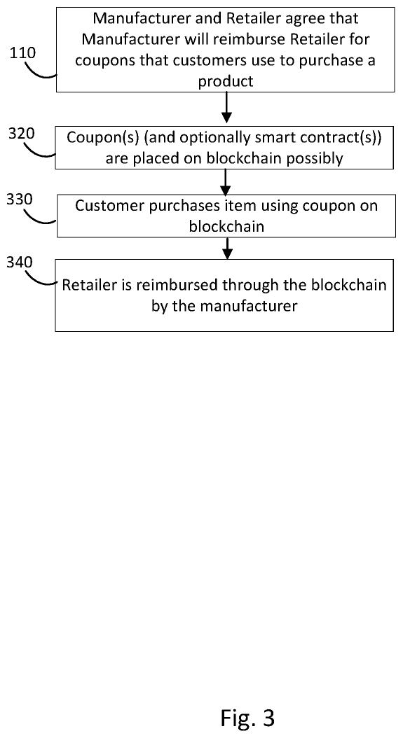

FIG. 3 illustrates an embodiment of a method described herein. In step 110, a manufacturer and retailer agree that the manufacturer will reimburse the retailer (possibly on a per coupon basis) for coupons that customers use to purchase a product(s). In step 320, the retailer (or possibly some other entity including the manufacturer) places coupon(s) on the blockchain. This may be done in the form of a single coupon, a book of coupons, a “magazine” with coupons and additional information, or any other form. In step 330, a customer purchases an item(s) using the blockchain coupon. In step 340, the retailer is reimbursed through the blockchain by the manufacturer. In some embodiments the reimbursement occurs as the point of sale. It should be noted that reimbursement at the point of sale provides the retailer the advantage of faster reimbursement when compared to the prior process of collecting coupons for an extended period of time before sending the coupons to the manufacturer for reimbursement. For example, in the previously known systems, before the retailer was reimbursed, there would be a first waiting period while the retailer collected coupons; subsequently, after the retailer send the collected coupons to the manufacture, there would be a second waiting period while the manufacturer prepared and sent the payment. Some embodiments described herein advantageously eliminate both of these waiting periods by, for example, simultaneously completing the purchase transaction and dispensing reimbursement to the retailer from the manufacturer.

As this illustrates, the embodiment of FIG. 3 reduces or eliminates the possibility for retailer fraud in collecting reimbursement from the manufacturer. For example, because the coupon use is recorded on the blockchain, a retailer is not able to fraudulently clip coupons from a printed publication and send them to the manufacturer. In this regard, it should be understood that transactions on the blockchain may be identified with an identification number, a time stamp, and other information recorded on the blockchain. In some embodiments, the identification number and timestamp are placed on the same block as the coupon on the blockchain. This is in contrast to paper coupons, which may have only had a barcode to identify the coupon, and this barcode would be the same for each coupon so individual transactions could not easily be identified. In addition, transactions on the blockchain may be publicly viewed/inspected because of the public ledger aspects of a blockchain.

Also advantageously, certain embodiments use blockchain technology to incorporate smart contracts. This allows for coupons that can be more specifically tailored by either the retailer or manufacturer. For example, a smart contract on the blockchain may allow certain coupon(s) to be valid for a certain time period (thus placing a “fuse” on the coupon), geographic area, or number of transactions (e.g. number of purchases using a particular coupon). In another example, a smart contract on the blockchain may allow certain coupon(s) to be only valid for a new opening of a specific store. In another example, a smart contract on the blockchain may allow certain coupon(s) to be only valid for particular retailer(s) or manufacturer(s). The advantages relating to the more specific tailoring of coupons with smart contracts is made possible specifically by the use of blockchain technology.

Another advantage is that the customer may use any form of currency to pay for the item. For example, the customer may use a cryptocurrency such as Bitcoin or Ethereum® (or any other cryptocurrency). In another example, the customer may use US dollars or any other traditional currency to pay. Also, the customer may use a quick response (QR) code as part of the transaction. For example, the QR code may identify the coupon on the blockchain. In some embodiments, the QR code is the parent ID for a single promotion (e.g. coupon) or group of promotions (e.g. group of coupons). In some embodiments, there is another database that houses QR code information that lives on the blockchain or in the cloud. In some embodiments, the payment information lives in the blockchain. In some embodiments, all transactional data associated with the promotions lives in the blockchain

In some embodiments, the coupons are pre-funded by the manufacturer.

It will be further appreciated that the techniques disclosed herein may be embodied by a non-transitory storage medium storing instructions readable and executable by an electronic data processing device to perform the disclosed techniques. Such a non-transitory storage medium may comprise a hard drive or other magnetic storage medium, an optical disk or other optical storage medium, a cloud-based storage medium such as a RAID disk array, flash memory or other non-volatile electronic storage medium, or so forth.

Of course, modifications and alterations will occur to others upon reading and understanding the preceding description. It is intended that the invention be construed as including all such modifications and alterations insofar as they come within the scope of the appended claims or the equivalents thereof.

1. A system comprising:
at least one processor;
and at least one memory including computer program code;
the at least one memory and the computer program code configured to, with the at least one processor, cause the system to:
using a coupon on a blockchain, complete a transaction between a retailer and a customer.

2. The system according to claim 1, wherein the at least one processor is configured to execute the computer-readable instructions to cause the system to:
using the coupon on the blockchain, dispense reimbursement to the retailer from a manufacturer.

3. The system according to claim 1, wherein the at least one processor is configured to execute the computer-readable instructions to cause the system to:
using the coupon on the blockchain, simultaneously complete the transaction and dispense reimbursement to the retailer from a manufacturer.

4. The system according to claim 1, wherein:
a smart contract on the blockchain indicates an amount that the retailer will be reimbursed per purchase by a manufacturer; and
the at least one processor is configured to execute the computer-readable instructions to cause the system to:
using the coupon on the blockchain and the smart contract on the blockchain, dispense reimbursement of the amount to the retailer from the manufacturer.

5. The system according to claim 1, wherein:
a smart contract on the blockchain indicates a number of transactions that the coupon is valid for.

6. The system according to claim 1, wherein:
a smart contract on the blockchain indicates a time period that the coupon is valid for.

7. The system according to claim 1, wherein:
a smart contract on the blockchain indicates a geographic area that the coupon is valid for.

8. The system according to claim 1, wherein:
a smart contract on the blockchain indicates a particular retailer that the coupon is valid for.

9. The system according to claim 1, wherein the at least one processor is configured to execute the computer-readable instructions to cause the system to:
place the coupon on the blockchain.

10. The system according to claim 1, wherein the at least one processor is configured to execute the computer-readable instructions to cause the system to:
place a book of coupons on the blockchain, wherein the book of coupons on the blockchain includes the coupon.

11. The system according to claim 1, wherein the at least one processor is configured to execute the computer-readable instructions to cause the system to:
place a book of coupons on the blockchain, wherein the book of coupons on the blockchain includes:
the coupon; and
an advertisement for a new store opening; and
execute a smart contract that limits the coupon to the new store opening.

12. The system according to claim 1, wherein the at least one processor is configured to execute the computer-readable instructions to cause the system to:
complete the transaction by receiving a quick response (QR) code from the customer.

13. The system according to claim 1, wherein the at least one processor is configured to execute the computer-readable instructions to cause the system to:
display, to the customer, all coupons on the blockchain corresponding to a particular store of a particular retailer.

14. The system according to claim 1, wherein the at least one processor is configured to execute the computer-readable instructions to cause the system to:
place a transaction identification number and timestamp corresponding to the transaction on the blockchain.

15. The system according to claim 1, wherein the blockchain is a private blockchain of the retailer or a manufacturer.

16. The system according to claim 1, wherein the at least one processor is configured to execute the computer-readable instructions to cause the system to:
complete the transaction using a cryptocurrency.

17. The system according to claim 1, wherein the coupon is part of a plurality of coupons pre-funded by a manufacturer.

18. The system according to claim 1, wherein:
a first smart contract on the blockchain indicates an amount that the retailer will be reimbursed per purchase by a manufacturer;
a second smart contract on the blockchain indicates a number of transactions that the coupon is valid for;
a third smart contract on the blockchain indicates a time period that the coupon is valid for;
a fourth smart contract on the blockchain indicates a geographic area that the coupon is valid for;
a fifth smart contract on the blockchain indicates a particular retailer that the coupon is valid for;
the blockchain is a private blockchain of the manufacturer;
the coupon is part of a plurality of coupons pre-funded by a manufacturer; and
the at least one processor is configured to execute the computer-readable instructions to cause the system to:
place a book of coupons on the blockchain, wherein the book of coupons on the blockchain includes the coupon, and an advertisement for a new store opening; and
display, to the customer, all coupons on the blockchain corresponding to the new store opening;
using the coupon on the blockchain and the first smart contract on the blockchain, simultaneously complete the transaction and dispense reimbursement of the amount to the retailer from the manufacturer, wherein the transaction includes receiving a quick response (QR) code from the customer; and
place a transaction identification number and timestamp corresponding to the transaction on the blockchain.

19. A method, performed by one or more processors, comprising:
using a coupon on a blockchain to complete a transaction between a retailer and a customer.

20. A system comprising one or more processors configured to:
use a coupon on a blockchain to complete a transaction between a retailer and a customer.
